(19) United States
(12) Patent Application Publication
(10) Pub. No.: US 2011/0298787 A1
(43) Pub. Date: Dec. 8, 2011

(54) LAYER COMPOSITION, RENDERING, AND ANIMATION USING MULTIPLE EXECUTION THREADS

(76) Inventors: Daniel Feies, Kirkland, WA (US); Scott Bassett, Redmond, WA (US); Adam Christopher Czeisler, Seattle, WA (US); Jeremiah S. Epling, Redmond, WA (US)

(21) Appl. No.: 12/791,888

(22) Filed: Jun. 2, 2010

(51) Int. Cl. G06T 15/00

(52) U.S. Cl. 345/419

(57) ABSTRACT

Architecture that creates an independent system which takes as input standard 2D layers and composites and renders the layers in 3D. Hardware accelerated graphics effects can be added to these layers, and additionally, the layers can be animated independently. Layer types provided include CPU, bitmap, GPU, and Direct2D. The layers are organized in trees and the layer manager handles the layers composition, rendering, and animations on hardware or software devices. Layers have properties such as visibility, 3D coordinates, for example. Animations and transitions can be provided at the layer and layer property level.

### BACKGROUND

Applications that use rendering technologies do not support glitch free animations and composition in 3D space. Moreover, the technologies are not hardware accelerated, thus, animation and composition on software devices exhibit poor performance. Systems exist that allow for 3D rendering and animation; however, in order to use these features, applications must be completely redesigned and rewritten, thereby introducing entry barriers that are costly for most applications.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture creates an independent system that takes as input standard 2D (two-dimension) surfaces (called “layers”) and composites and renders the surfaces in 3D (three-dimension). Hardware accelerated graphics effects can be added to these layers, and additionally, the layers can be animated independently.

Layer types provided in the architecture include, but are not limited to, CPU (central processing unit), bitmap, GPU (graphics processing unit), and Direct2D, and an extensibility model to add more layer types. The layers are organized in trees and a layer manager handles the layers composition, rendering, and animations on hardware and/or software devices. Layers have properties such as visibility, and 3D coordinates, for example. Animations and transitions can be provided at the layer and layer property level.

Moreover, an application can render to different layer types provided by the system and issue synchronous and asynchronous commands. For example, a legacy application using (e.g., using GDI (graphics device interface) or GDI+) can render to a CPU or to a bitmap layer, and the legacy application can issue animation commands that will animate the layer on a separate rendering thread and using the GPU, if available.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a graphics system in accordance with the disclosed architecture.

FIG. 2 illustrates a detailed embodiment of a system for rendering, composition, and animation using multiple execution threads.

FIG. 3 illustrates a graphics processing method in accordance with the disclosed architecture.

FIG. 4 illustrates further aspects of the method of FIG. 3.

FIG. 5 illustrates a block diagram of a computing system that executes independent graphics thread processing in accordance with the disclosed architecture.

### DETAILED DESCRIPTION

The disclosed architecture creates an independent system that works separate from application processes, but in combination with process threads by taking as input standard 2D surfaces (called “layers”) and, composites and renders the surfaces in 3D on a separate rendering/composition/animation thread. Hardware accelerated graphics effects can be added to these layers and the layers can be animated independently by the independent system. The system provides layer types that include CPU (central processing unit), bitmap, GPU (graphics processing unit), Direct2D (a 2D and vector graphics API by Microsoft Corporation), including an extensibility model to add more layer types). The layers are organized in trees and the layer manager handles the layers composition, rendering and animations on hardware or software devices. Layers have properties like visibility, 3D coordinates and more. The system provides animations and transitions at the layer and layer property level.

An application can render to different layer types provided by the system and issue sync and async commands as needed to the graphics thread. For example a legacy application using GDI (graphics device interface) and GDI+ (both by Microsoft Corporation) can render to a CPU and/or to a bitmap layer and issue animation commands that will animate the layer on a separate rendering thread and using the GPU, if available.

The architecture provides methods to create and manage different layers types, to composite layers in 3D, to send and process commands, events and notifications between threads, to schedule animation and transitions on layers, and to interoperate with legacy rendering and graphical systems.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

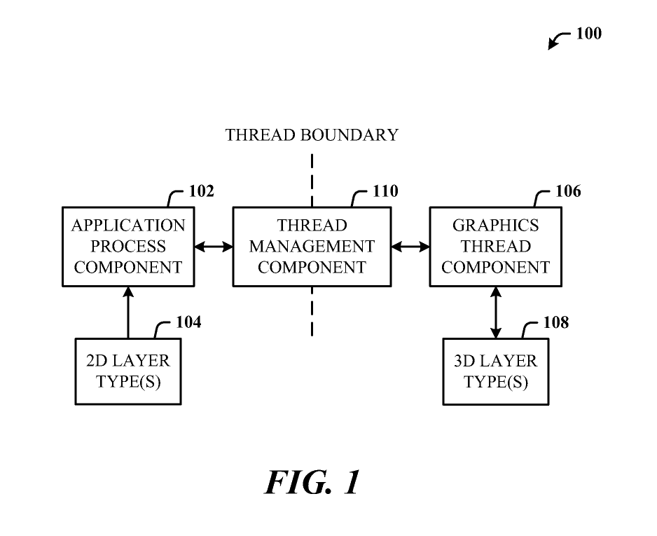

FIG. 1 illustrates a graphics system 100 in accordance with the disclosed architecture. The system 100 includes an application process component 102 created to handle a two-dimensional (2D) layer type 104 for graphics output, and an independent graphics thread component 106 created to receive the 2D layer type 104 and process the 2D layer type 104 into a greater-dimensional scene (e.g., 3D layer type 108). The independent graphics thread component 106 performs rendering, composition, and/or animation of the 2D layer type 104 into 3D space.

The system 100 can further comprise a thread management component 110 that creates a channel via which commands, events, and notifications are communicated between the independent graphics thread component 106 and the application process component 102. Code of the thread management component 110 runs on the application process component 102 and on the independent graphics thread component 106. The 2D layer type 104 is one of many layer types structured as a layer tree in the application process component 102. The independent graphics thread component 106 renders the layer tree when receiving commands from the application process component 102 and updates from an animation manager of the graphics thread component 106.

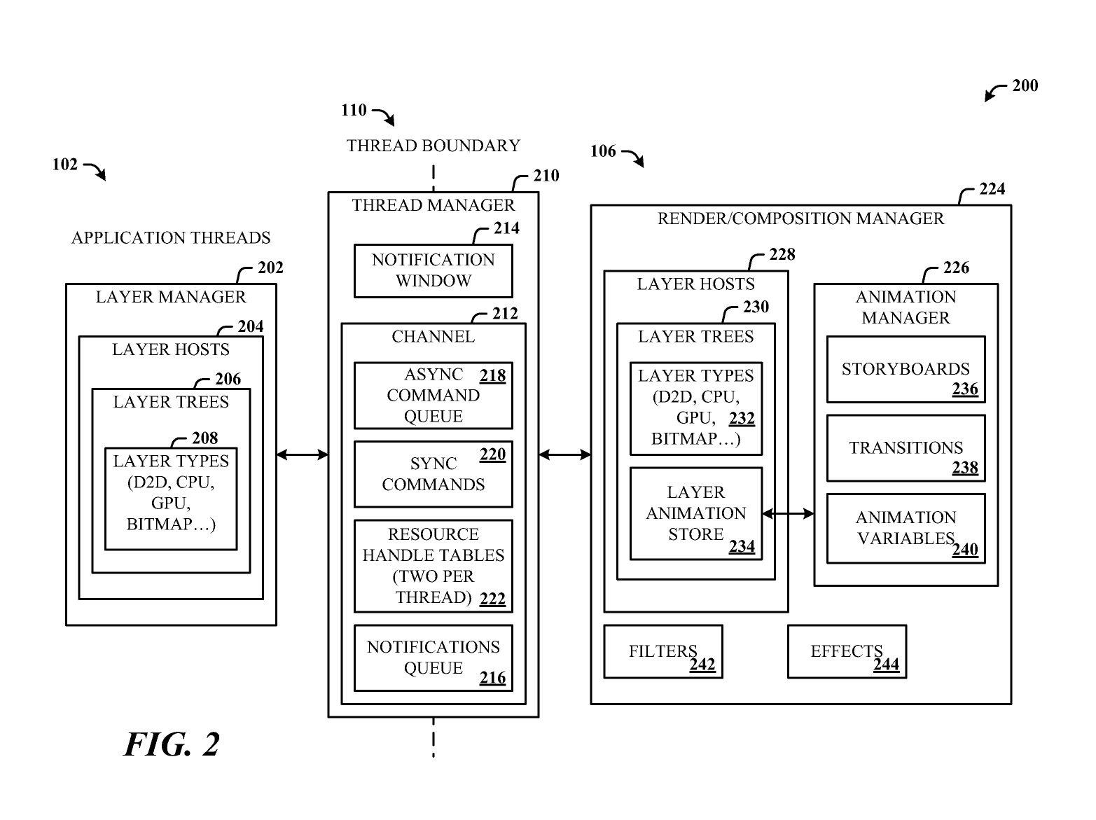

FIG. 2 illustrates a detailed embodiment of a system 200 for rendering, composition, and animation using multiple execution threads. The system 200 includes three major components: the application process component 102, the independent graphics thread component 106 and the thread management component 110.

The application process component 102 can include one or more process threads for handling graphics for presentation via the associated application. The application creates a layer manager 202, which handles the rendering of its layers, the layer hosts 204 (for the multiple 2D layer types). A layer host is an object that associates with typical application windows. Once the application creates the layer hosts 204 for the windows, layer trees 206 are created inside the windows (for each layer host). Thus, each physical window has a layer tree 206 (e.g., a rectangle). The layer tree(s) can render different layer types 208 depending on what is rendered in the layer (e.g., CPU, GPU, bitmap, etc.). The application creates the layers based on need; thus if two layers are needed, two layers are created.

The system 200 then creates the thread management component 110, which include a thread manager 210, and one or more channels (e.g., a channel 212) for managing communications between the layer manager 202 and the graphics thread component 106. A separate channel is created for each application thread (of the application process component 102) that uses the graphics thread component 106. Commands are communicated via the channel 212 to a single and different graphics thread component 106.

The thread manager 210 includes a notification window 214 for presenting notifications associated with notifications queue 216 for the channel 212. The channel 212 also has an associated asynchronous command queue 218 for handling asynchronous commands, synchronous commands 220, and resource handle tables 222 (two tables per application thread), which track the list of current layer types.

The graphics thread component 106 includes a render/composition manager 224 and an animation manager 226. The render/composition manager 224 creates layer hosts 228, a layer tree 50 for each of the hosts 228, and associated layer types 232. Additionally, a layer animation store 234 is created and interfaces to the animation manager 226. The animation manager 226 includes storyboards 236 (for organizing animations), transitions 238 (for moving between animations) and animation variables 240 (e.g., graphical manipulations, etc.). As shown, the render/composition manager 224 can also include filters 242 and effects 244.

More specifically, the application thread component 102 exposes the APIs used by the client applications to use the disclosed independent graphics thread system. The APIs can be implemented using a class factory (in a COM (component object model) implementation by Microsoft Corporation). A class factory object implements an IUnknown interface and a set of interfaces derived from IUnknown.

The layer manager 202 of the application process component 102 is the object that controls the lifetime of the application process thread component 102 and provides the entry points for the system. The layer manager 202 also acts as a class factory for the other process component objects.

All objects on the process component 102 are thin wrappers around the resources managed by the handle tables 222. Calls through the process component API are converted into a command with parameters, which is serialized and posted into the async command queue 218. If the command is synchronous, the command is sent immediately to the graphics thread component 106 and then the application thread (of the process component 102) is stopped until the command is completed.

With respect to the thread management component 110, the code in the thread management component 110 runs in the application thread and on the independent graphics thread (of the graphics component 106). The thread management component 110 handles the management of the application thread (create and destroy), registration of application threads, management of the channels (e.g., channel 212), communications between the application threads and the graphic thread, unpacking and dispatching of sync and async commands and, unpacking and dispatching of the notifications that use the notifications queue 216.

The graphics thread handles the rendering of the layers using hardware accelerated graphics (GPU) and/or software graphics (CPU). The layers are organized as trees and managed by the layer host objects. The graphics thread component 106 renders the layer trees 230 when receiving commands from the application thread and when receiving updates from the animation manager 240.

When using a GPU, the graphics thread handles error cases such as “device lost”, and sends notifications to the application components 102 to allow resource recreations. The filters 242 and effects 244 can be applied on the layers to change the appearance. The implementation can be done in the CPU (core(s)) and/or GPU.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

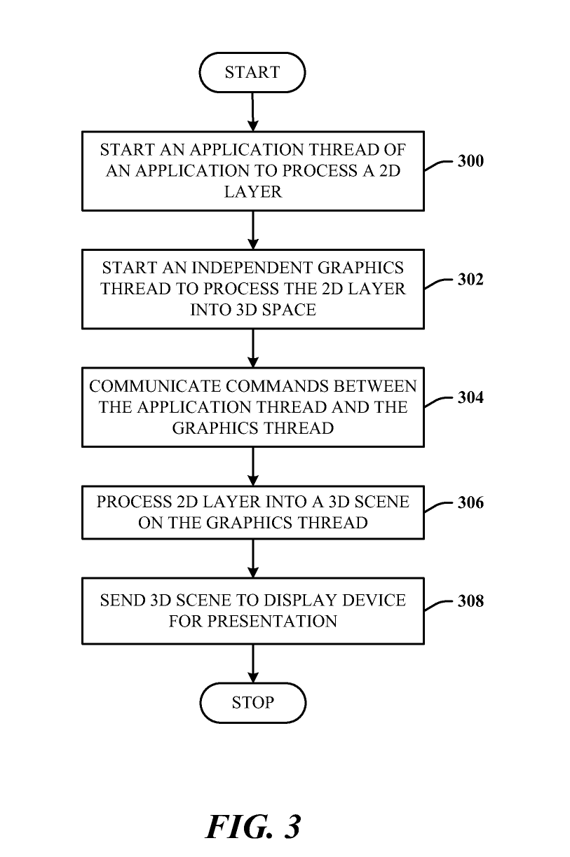

FIG. 3 illustrates a graphics processing method in accordance with the disclosed architecture. At 300, an application thread of an application is started to process a 2D layer. At 302, an independent graphics thread is started to process the 2D layer into 3D space. At 304, commands are communicated between the application thread and the graphics thread. At 306, the 2D layer is processed into a 3D scene on the graphics thread. At 308, the 3D scene is sent to a display device for presentation.

The process begins with the application creating the layer manager for the application thread. Then, the layer host is created to associate objects with windows. Then the layer tree is created for the window. Each physical window now has layer tree. For example, the layer tree can be associated with a rectangle, and be of different types, depending on the technology employed (e.g., D2D, GPU, CPU, bitmap, etc.).

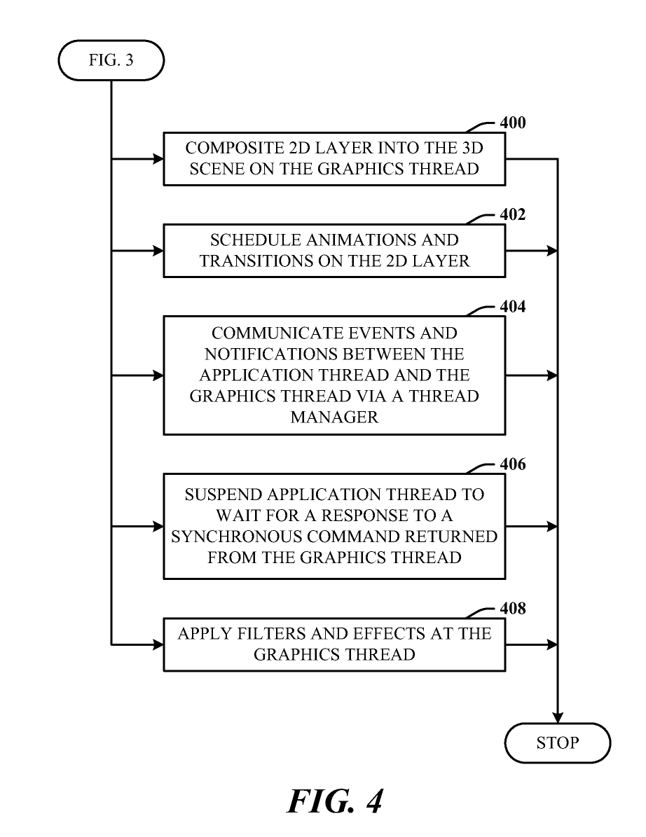

FIG. 4 illustrates further aspects of the method of FIG. 3. At 400, the 2D layer is composited into the 3D scene on the graphics thread. At 402, animations and transitions are scheduled on the 2D layer. At 404, events and notifications are communicated between the application thread and the graphics thread via a thread manager. At 406, the application thread is suspended to wait for a response to a synchronous command returned from the graphics thread. At 408, filters and effects are applied at the graphics thread.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

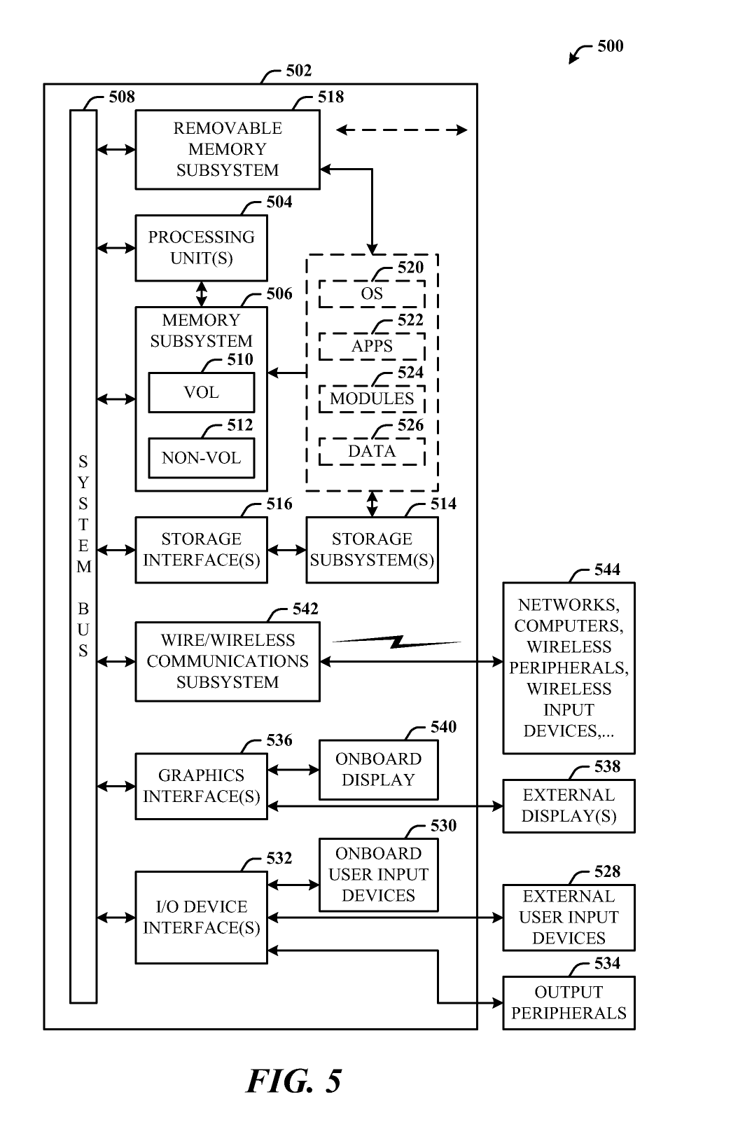

Referring now to FIG. 5, there is illustrated a block diagram of a computing system 500 that executes independent graphics thread processing in accordance with the disclosed architecture. In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 500 for implementing various aspects includes the computer 502 having processing unit(s) 504, a computer-readable storage such as a system memory 506, and a system bus 508. The processing unit(s) 504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 506 can include computer-readable storage (physical storage media) such as a volatile (VOL) memory 510 (e.g., random access memory (RAM)) and non-volatile memory (NON-VOL) 512 (e.g., ROM, EPROM, EEPROM, etc.). A basic input/output system (BIOS) can be stored in the non-volatile memory 512, and includes the basic routines that facilitate the communication of data and signals between components within the computer 502, such as during startup. The volatile memory 510 can also include a high-speed RAM such as static RAM for caching data.

The system bus 508 provides an interface for system components including, but not limited to, the system memory 506 to the processing unit(s) 504. The system bus 508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 502 further includes machine readable storage subsystem(s) 514 and storage interface(s) 516 for interfacing the storage subsystem(s) 514 to the system bus 508 and other desired computer components. The storage subsystem(s) 514 (physical storage media) can include one or more of a hard disk drive (HDD), a magnetic floppy disk drive (FDD), and/or optical disk storage drive (e.g., a CD-ROM drive DVD drive), for example. The storage interface(s) 516 can include interface technologies such as EIDE, ATA, SATA, and IEEE 1394, for example.

One or more programs and data can be stored in the memory subsystem 506, a machine readable and removable memory subsystem 518 (e.g., flash drive form factor technology), and/or the storage subsystem(s) 514 (e.g., optical, magnetic, solid state), including an operating system 520, one or more application programs 522, other program modules 524, and program data 526.

The one or more application programs 522, other program modules 524, and program data 526 can include the entities and components of the system 100 of FIG. 1, the entities and components of the system 200 of FIG. 2, and the methods represented by the flowcharts of FIGS. 3-4, for example.

Generally, programs include routines, methods, data structures, other software components, etc., that perform particular tasks or implement particular abstract data types. All or portions of the operating system 520, applications 522, modules 524, and/or data 526 can also be cached in memory such as the volatile memory 510, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 502 and includes volatile and non-volatile internal and/or external media that is removable or non-removable. For the computer 502, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 502, programs, and data using external user input devices 528 such as a keyboard and a mouse. Other external user input devices 528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 502, programs, and data using onboard user input devices 530 such a touchpad, microphone, keyboard, etc., where the computer 502 is a portable computer, for example. These and other input devices are connected to the processing unit(s) 504 through input/output (I/O) device interface(s) 532 via the system bus 508, but can be connected by other interfaces such as a parallel port, IEEE 1394 serial port, a game port, a USB port, an IR interface, etc. The I/O device interface(s) 532 also facilitate the use of output peripherals 534 such as printers, audio devices, camera devices, and so on, such as a sound card and/or onboard audio processing capability.

One or more graphics interface(s) 536 (also commonly referred to as a graphics processing unit (GPU)) provide graphics and video signals between the computer 502 and external display(s) 538 (e.g., LCD, plasma) and/or onboard displays 540 (e.g., for portable computer). The graphics interface(s) 536 can also be manufactured as part of the computer system board.

The computer 502 can operate in a networked environment (e.g., IP-based) using logical connections via a wired/wireless communications subsystem 542 to one or more networks and/or other computers. The other computers can include workstations, servers, routers, personal computers, microprocessor-based entertainment appliances, peer devices or other common network nodes, and typically include many or all of the elements described relative to the computer 502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 502 connects to the network via a wired/wireless communication subsystem 542 (e.g., a network interface adapter, onboard transceiver subsystem, etc.) to communicate with wired/wireless networks, wired/wireless printers, wired/wireless input devices 544, and so on. The computer 502 can include a modem or other means for establishing communications over the network. In a networked environment, programs and data relative to the computer 502 can be stored in the remote memory/storage device, as is associated with a distributed system. It will be appreciated that the network connections shown are exemplary and other means of establishing a communications link between the computers can be used.

The computer 502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A graphics system, comprising:
an application process component created to handle a two-dimensional (2D) layer type for graphics output; and
an independent graphics thread component created to receive the 2D layer type and process the 2D layer type into a greater-dimensional scene.

2. The system of claim 1, wherein the independent graphics thread component performs rendering of the 2D layer type.

3. The system of claim 1, wherein the independent graphics thread component performs composition of the 2D layer into 3D space.

4. The system of claim 1, wherein the independent graphics thread component performs animation of the 2D layer type.

5. The system of claim 1, further comprising a thread management component that creates a channel via which commands, events, and notifications are communicated between the independent graphics thread and the application process.

6. The system of claim 1, wherein code of the thread management component runs on the application process and on the independent graphics thread.

7. The system of claim 1, wherein the 2D layer type is one of many layer types structured as a layer tree in the application process component.

8. The system of claim 7, wherein the independent graphics thread component renders the layer tree when receiving commands from the application process component and updates from an animation manager.

9. A graphics system, comprising:
an application process component created to handle a 2D layer type for graphics output;
an independent graphics thread component created to receive the 2D layer type and process the 2D layer into a 3D scene; and
a thread management component that creates a channel via which commands, events, and notifications are communicated between the independent graphics thread component and the application process component.

10. The system of claim 9, wherein the independent graphics thread component performs rendering, composition, and animation of the 2D layer type.

11. The system of claim 9, wherein code of the thread management component runs on the application process component and on the independent graphics thread component.

12. The system of claim 9, wherein the layer type is one of many layer types structured as a layer tree in the application process component.

13. The system of claim 12, wherein the independent graphics thread component renders the layer tree when receiving commands from the application process component and updates from an animation manager.

14. The system of claim 9, wherein the thread management component creates and destroys the independent graphics thread component and, dispatches synchronous and synchronous commands between the application process component and the graphics thread component.

15. A computer-implemented graphics processing method executed by a processor, comprising:
starting an application thread of an application to process a 2D layer;
starting an independent graphics thread to process the 2D layer into 3D space;
communicating commands between the application thread and the graphics thread;
processing the 2D layer into a 3D scene on the graphics thread; and
sending the 3D scene to a display device for presentation.

16. The method of claim 15, further comprising compositing the 2D layer into the 3D scene on the graphics thread.

17. The method of claim 15, further comprising scheduling animations and transitions on the 2D layer.

18. The method of claim 15, further comprising communicating events and notifications between the application thread and the graphics thread via a thread manager.

19. The method of claim 15, further comprising suspending the application thread to wait for a response to a synchronous command returned from the graphics thread.

20. The method of claim 15, further comprising applying filters and effects at the graphics thread.
